(19) United States
(12) Patent Application Publication
(10) Pub. No.: US 2013/0032425 A1
(43) Pub. Date: Feb. 7, 2013

(54) BICYCLE TRANSMISSION DEVICE

(71) Applicants: SEN-YUNG LEE, TAINAN CITY (TW); YIH-RAN SHEU, TAINAN CITY (TW); YUNG-CHANG CHENG, TAINAN CITY (TW); JER-JIA SHEU, TAINAN CITY (TW); SHIH-WEN HSIAO, TAINAN CITY (TW); TING-WEI LIN, TAINAN CITY (TW); CHENG-CHE LIN, TAINAN CITY (TW)

(72) Inventors: SEN-YUNG LEE, TAINAN CITY (TW); YIH-RAN SHEU, TAINAN CITY (TW); YUNG-CHANG CHENG, TAINAN CITY (TW); JER-JIA SHEU, TAINAN CITY (TW); SHIH-WEN HSIAO, TAINAN CITY (TW); TING-WEI LIN, TAINAN CITY (TW); CHENG-CHE LIN, TAINAN CITY (TW)

(73) Assignee: NATIONAL CHENG KUNG UNIVERSITY, TAINAN CITY (TW)

(21) Appl. No.: 13/557,267

(22) Filed: Jul. 25, 2012

(30) Foreign Application Priority Data
Aug. 3, 2011 (TW) 100127481

(51) Int. Cl. B62M 6/55; B62M 9/00; B62M 6/40

(52) U.S. Cl. 180/220

(57) ABSTRACT

The bicycle transmission device includes a hollow tube extending through the bottom bracket and two caps are connected to two ends of the hollow tube. A motor unit has two extensions and multiple fixing assemblies, wherein the extensions are positioned by the caps. The fixing assemblies fix the motor unit to the underside of the bicycle. A shaft extends through the hollow tube and a first one-way transmission device is connected to one end of the shaft. A chainwheel and a first passive wheel are connected to the other end of the transmission shaft. Two cranks are connected to two ends of the transmission shaft. A motor located in the motor unit and has a second passive wheel. The first and second passive wheels transmit energy via the belt. The present invention reduces the space required for the motor and balances the weight of the bicycle.

### FIELD OF THE INVENTION

The present invention relates to a bicycle transmission device, and more particularly, to an electric transmission device suitable for any type of bicycles.

### BACKGROUND OF THE INVENTION

Bicycles are environmental friendly transportation means because no carbon-dioxide is generated. In order to reduce the riders' effort and energy, electric bicycles are developed and the electric bicycles are powered by motors. The electric bicycles are welcomed and used widely.

However, the prices for the electric bicycles are high and reduce the intensions of the users to purchase them, therefore, the old auto bikes that consume gasoline are still used. Furthermore, different users prefer different styles of the bicycles, and the electric transmission devices cannot be installed all of the existed bicycles. Especially for the foldable bicycles, the electric transmission devices are difficult to be installed thereto. The conventional electric transmission devices are usually make integrally with the bicycle frames, the individual electric transmission devices cannot be directly connected to the existed bicycle frames. This restricts the applications of the electric transmission devices. The conventional electric bicycles install the motor co-axially with the crank so that the users feel uncomfortable when pedaling the pedals. Besides, the motor usually located on one of two ends of the bottom bracket and the motor is heavy which affects the balance of the bicycle. The center of weight of the conventional electric bicycles is high and may cause lateral fall-down when turning.

The way of transmission for the conventional electric transmission devices is that the motor directly drives the front chainwheel or the rear chainwheel, the front wheel or the rear wheel then drives the bicycle to move forward. Nevertheless, when the electric power is low, the rider has to pedal the bicycle manually. When the motor has high torque, the rider has to apply several times of the force to overcome the magnetic force between the rotor and the stator of the motor to move the bicycle. This is not convenient for the riders.

The modern electric transmission devices have switch device for switching the electric operation mode and auxiliary electric operation mode. When in the auxiliary electric operation mode, the bicycle is driven forward by partial manual operation and partial electric transmission operation. When in the auxiliary electric operation mode, the auxiliary driving force is that the pre-set driving force minuses the manual force. Because the pre-set driving force is fixed, so that the auxiliary driving force is variable according to the manual force. When the manual force is reduced, the auxiliary driving force can be suddenly increased, such as the bicycle moves along a down-slope road, and this could cause accidents. Some electric transmission device has a sensor to control the auxiliary driving force. The sensor is installed at the connection portion between the pedal and crank so as to detect the rate of the pedaling to control the auxiliary driving force. However, if the rider does not pedal the pedals or the pedaling direction is not identical with that of the wheels, the bicycle is moving and the sensor may generate a wrong signal and responds in an incorrect way.

The present invention intends to provide an electric transmission device for bicycles and the electric transmission device improves the shortcomings of the conventional electric transmission devices.

### SUMMARY OF THE INVENTION

The present invention relates to a bicycle transmission device and comprises a hollow tube extending through a multiple-opening tube of a bicycle frame and two caps are respectively connected to two ends of the hollow tube. Each cap has a protrusion. A motor unit has two extensions and multiple fixing assemblies, wherein the extensions are located corresponding to the two protrusions and secured on the two ends of the multiple-opening tube by the two caps. The fixing assemblies fixing the motor unit to the bicycle frame. A shaft extends through the hollow tube, wherein the first end of the shaft extends through the cap and has a first one-way transmission device connected thereto, and the second end of the shaft extends through the other cap and has a chainwheel and a first passive wheel connected thereto. Two cranks are respectively connected to the first and second end of the shaft. A motor is located in the motor unit and has a second passive wheel which is connected with the first passive wheel by a belt.

Preferably, the multiple-opening tube is the bottom bracket.

Preferably, the fixing assemblies each have a lug on the motor unit and pivotably connected to a contact portion. The contact portion is rotatable relative to the lug.

Preferably, the fixing assemblies each have a lug on the motor unit and pivotably connected to a contact portion. The contact portion is rotatable relative to the lug and has a support portion which is movable on the contact portion.

Preferably, the hollow tube has a coated portion mounted to the outside thereof to obtain different diameters and to fit with the poly-opening tube.

Preferably, the first one-way transmission device is driven by the cranks and the first one-way transmission device indirectly drives the shaft. The cranks drive the chainwheel by rotating in one direction.

Preferably, the motor has a second one-way transmission device which is operated in opposite direction from that of first one-way transmission device, so that the cranks drive the chainwheel in both directions.

Preferably, the first one-way transmission device is driven by the cranks and the first one-way transmission device indirectly drives the shaft. The cranks drive the chainwheel by rotating in one direction.

Preferably, a magnetic induction member is connected to the extension and located close to an end of the first one-way transmission device. A ring is located between the extension and the first one-way transmission device. The ring has multiple recesses and each of the recesses receives a magnet. The magnetic induction member induces changes of magnetic field when the first one-way transmission device is rotated relative to the magnets.

Preferably, a speed-restriction device is connected with the motor and restricts speed of the motor by the induction of the changes of magnetic field.

The primary object of the present invention is to provide a bicycle transmission device for bicycles and the bicycle transmission device can be installed to different types of bicycles so as to drive the bicycles by electric power. The bicycle transmission device can be operated under the electric operation mode or the auxiliary electric operation mode. The space for installation of the motor is reduced and the weight balance is maintained on the left side and right side of the bicycle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle transmission device of the present invention;

FIG. 2 is an exploded view to show the bicycle transmission device of the present invention;

FIG. 3 is a cross sectional view showing that the bicycle transmission device is installed to the bottom bracket of the bicycle frame;

FIG. 4 shows that the hollow tube is to be connected to the bottom bracket;

FIG. 5 shows the exploded view of the motor unit, first one-way transmission device and the magnetic induction member;

FIG. 6 is an exploded view to show that the motor unit and the bicycle bottom bracket of the present invention;

FIG. 7 is a side view to show that the bicycle transmission device of the present invention is installed to a bicycle;

FIG. 8 is another side view to show that the bicycle transmission device of the present invention is installed to a bicycle; FIG. 9 is yet another side view to show that the bicycle transmission device of the present invention is installed to a bicycle;

FIG. 10 is a perspective view to show the second embodiment of the bicycle transmission device of the present invention;

FIG. 11 is an exploded view to show the second embodiment of the bicycle transmission device of the present invention;

FIG. 12 is an exploded view to show that the motor unit of the second embodiment of the bicycle bottom bracket of the present invention and the bottom bracket of the bicycle;

FIG. 13 is a perspective view to show the third embodiment of the bicycle bottom bracket of the present invention;

FIG. 14 is an exploded view to show the third embodiment of the bicycle transmission device of the present invention;

FIG. 15 is a side view to show that the third embodiment of the bicycle transmission device of the present invention is installed to a bicycle; FIG. 16 is a perspective view to show the fourth embodiment of the bicycle transmission device of the present invention, and

FIG. 17 is an exploded view to show the fourth embodiment of the bicycle transmission device of the present invention.

### DETAILED DESCRIPTION OF THE PREFERRED EMBODIMENT

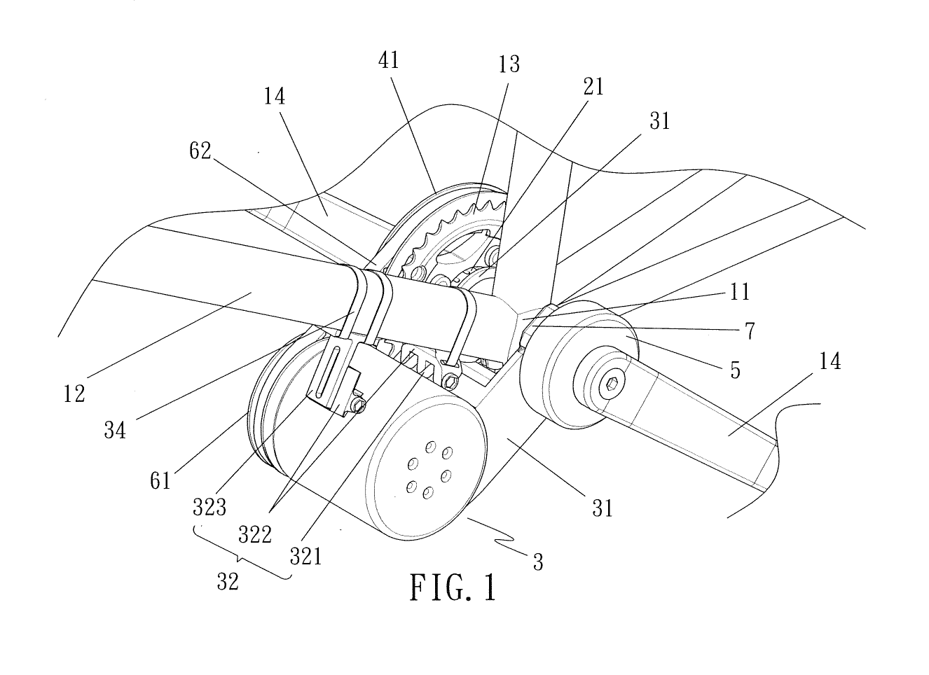

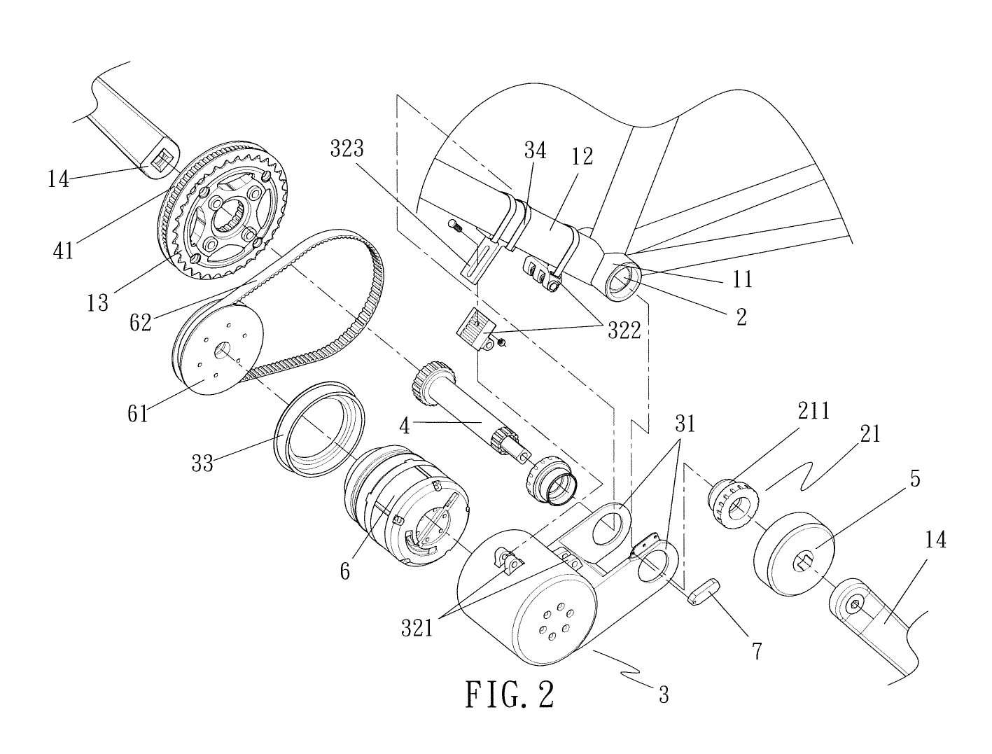

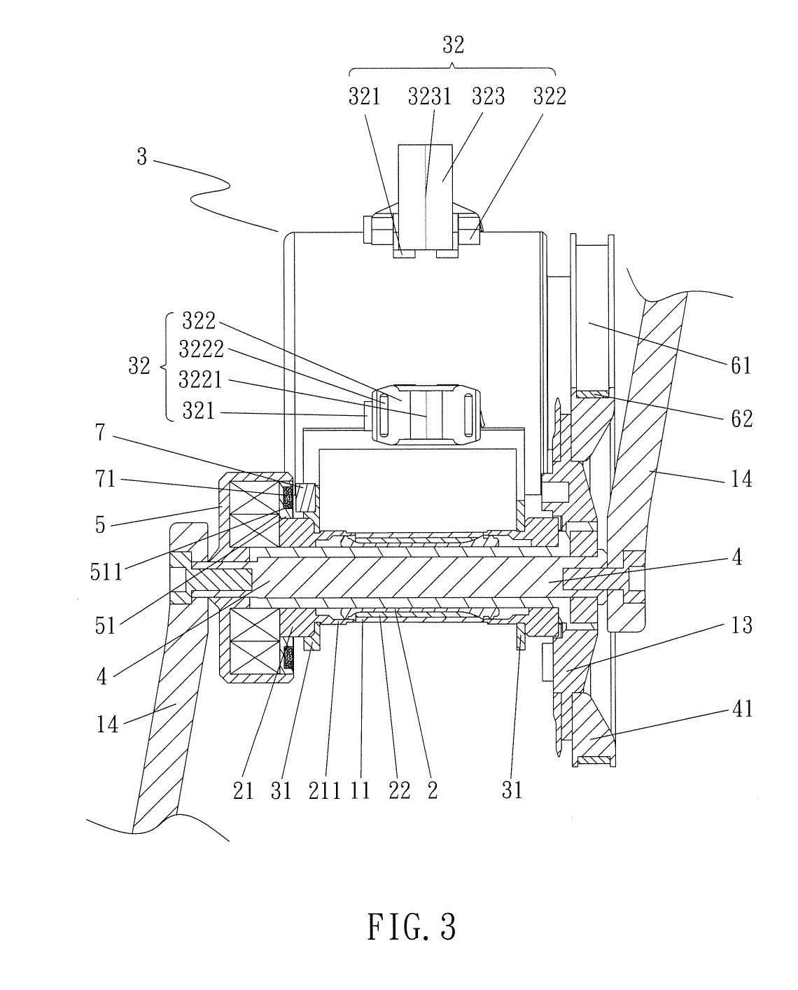

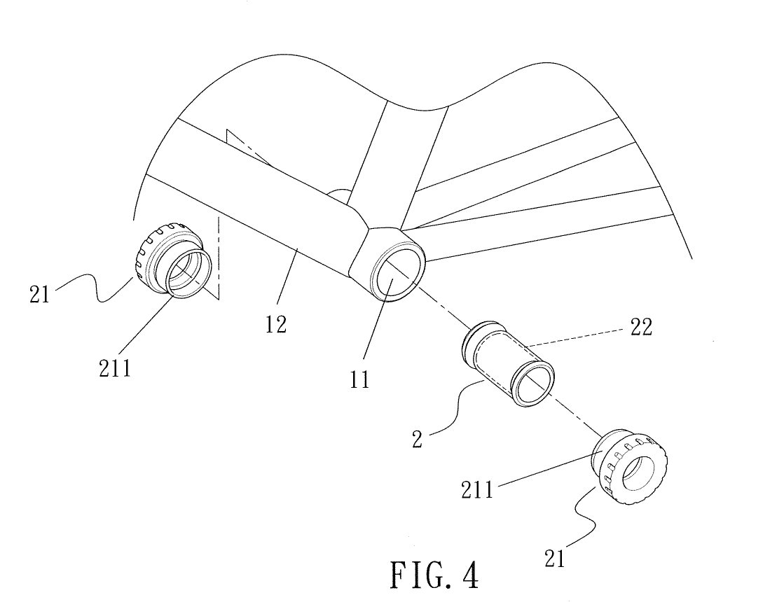

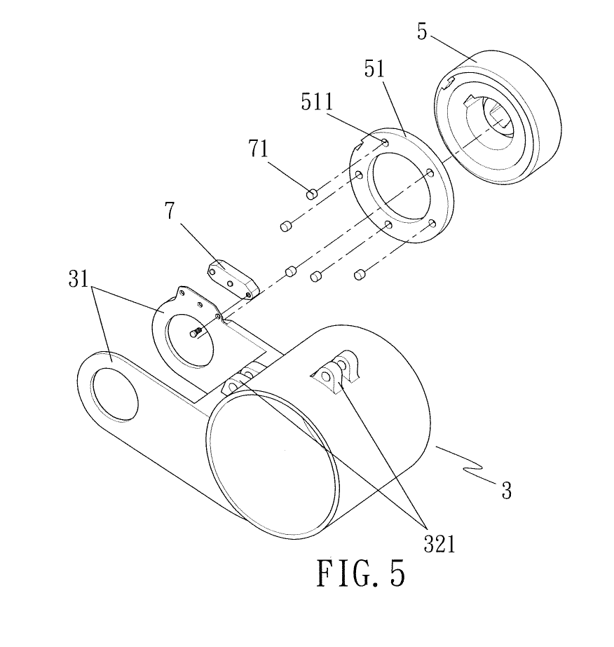

Referring to FIGS. 1 to 6, the bicycle transmission device for bicycles of the present invention comprises a hollow tube 2 extending through a multiple-opening tube which is the bottom bracket 11 of a bicycle frame 12. The diameter of the hollow tube 2 can be varied by mounting a coated portion 22 to the outside of the hollow tube 2 as shown in FIG. 4 so as to fit with the bottom brackets 11 of different diameters. Two caps 21 are respectively connected to two ends of the hollow tube 2 and each cap 21 has a protrusion 211.

A motor unit 3 has two extensions 31 and multiple fixing assemblies 32, the extensions 31 are located corresponding to the two protrusions 211 and secured on the two ends of the multiple-opening tube 11 by the two caps 21, so that the motor unit 3 is connected to the bottom bracket 11 of the bicycle frame 12. The fixing assemblies 32 each have a lug 321 on the motor unit 3 and pivotably connected to a contact portion 322, the contact portion 322 is rotatable relative to the lug 321 so as to be connected to different shapes of the bicycles 1. The contact portion 322 can be adjusted to a proper position to contact the underside of the bicycle frame 12. The contact portion 322 has a groove 3221 with which the cables of the underside of the bicycle frame 12 are engaged to keep the contact portion 322 matching tightly with the bicycle frame 12. The contact portion 322 has a hole 3222 and a clamp 34 extends through the hole 3222 of the contact portion 322 to clamp onto the bicycle frame 12 to fix the motor unit 3. The contact portion 322 has a support portion 323 pivotably connected thereto and the support portion 323 is movable on the contact portion 322. By this way, the adjustment range for the fixing assembly 32 is wider so as to contact different shapes of the bicycles 1. The support portion 323 has a groove 3231 for positioning the cables at the underside of the bicycle 1 and the clamp 34 secures the support portion 323 to the bicycle frame 12. Therefore, the fixing assembly 32 can be adjusted in different directions and the motor unit 3 can be installed to different bicycle frames 12. The motor unit 3 has a collar 33.

A shaft 4 extends through the hollow tube 2. The first end of the shaft 4 extends through the cap 21 and has a first one-way transmission device 5 connected thereto. The second end of the shaft 4 extends through the other cap 21 and has a chainwheel 13 and a first passive wheel 41 connected thereto. The first passive wheel 41 is engaged with the chainwheel 13 and the two cranks 14 respectively connected to the first and second end of the shaft 4. The shaft 4, the chainwheel 13 and the first passive wheel 41 are co-rotated.

The first one-way transmission device 5 is driven by the cranks 14 and the first one-way transmission device 5 indirectly drives the shaft 4 in one direction. Accordingly, the cranks 14 drive the chainwheel 13 by rotating in one direction.

A motor 6 is located in the motor unit 3 and secured by the collar 33. The motor 6 has a second passive wheel 61 which is connected with the first passive wheel 41 by a belt 62. The motor 6 has a second one-way transmission device 63 which is operated in opposite direction from that of first one-way transmission device 5. The motor 6 drives the chainwheel 13 in one direction by the second one-way transmission device 63, also, the cranks 14 drive the chainwheel 13 in both directions by the first and second one-way transmission device 5, 63.

A magnetic induction member 7 is connected to the extension 31 and located close to one end of the first one-way transmission device 5. A ring 51 is located between the extension 31 and the first one-way transmission device 5. The ring 51 has multiple recesses 511 and each of the recesses 511 receives a magnet 71. Only when the user pedals the cranks 14 in the identical direction with the movement of the bicycle 1, the ring 51 is rotated. The magnetic induction member 7 induces the changes of magnetic field when ring 51 is rotated relative to the magnets 71 and does not misjudge the movement direction of the bicycle 1 and the direction that the cranks 14 are rotated. A speed-restriction device 64 is connected with the motor 6. When the first one-way transmission device 5 and the second one-way transmission device 6 both drive the chaiwheel 13, the speed-restriction device 64 restricts speed of the motor 6 according to the induction of the changes of magnetic field.

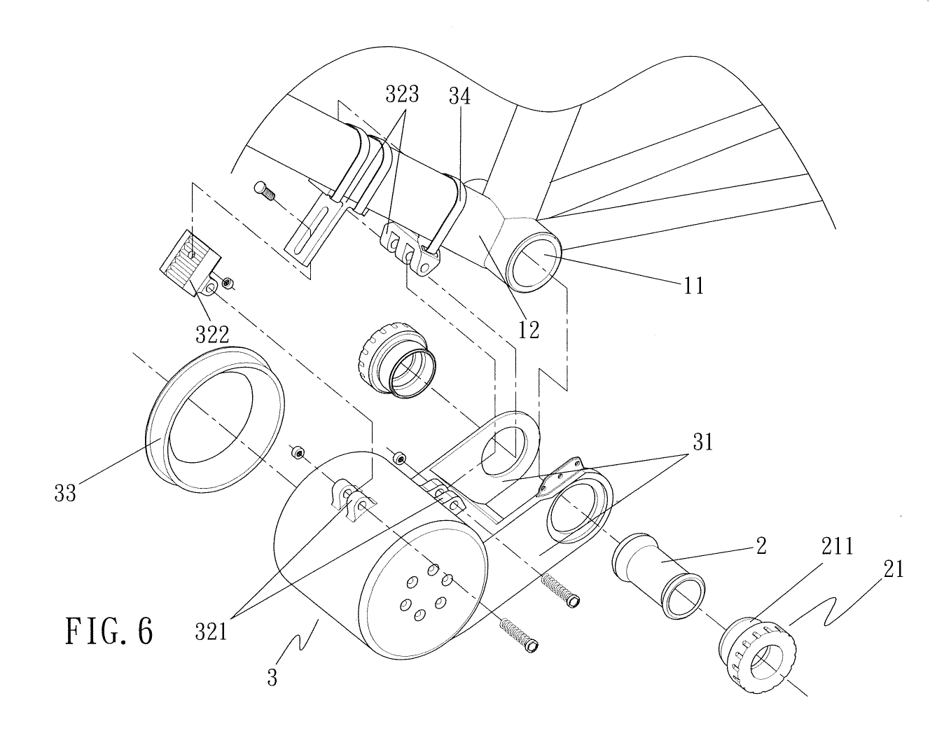

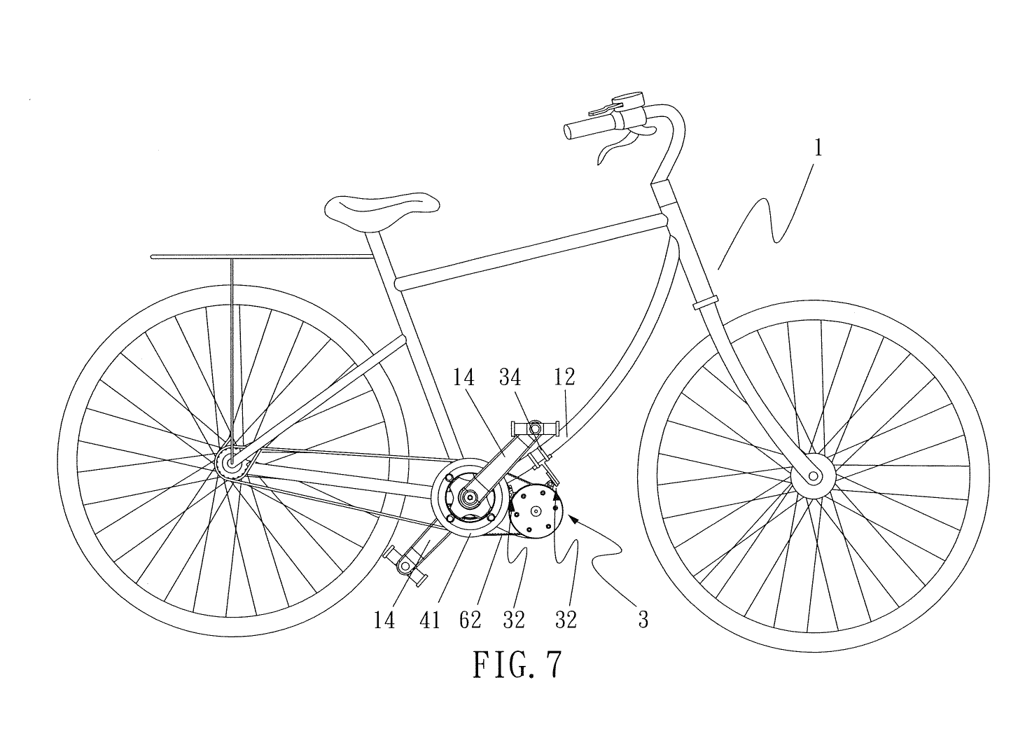

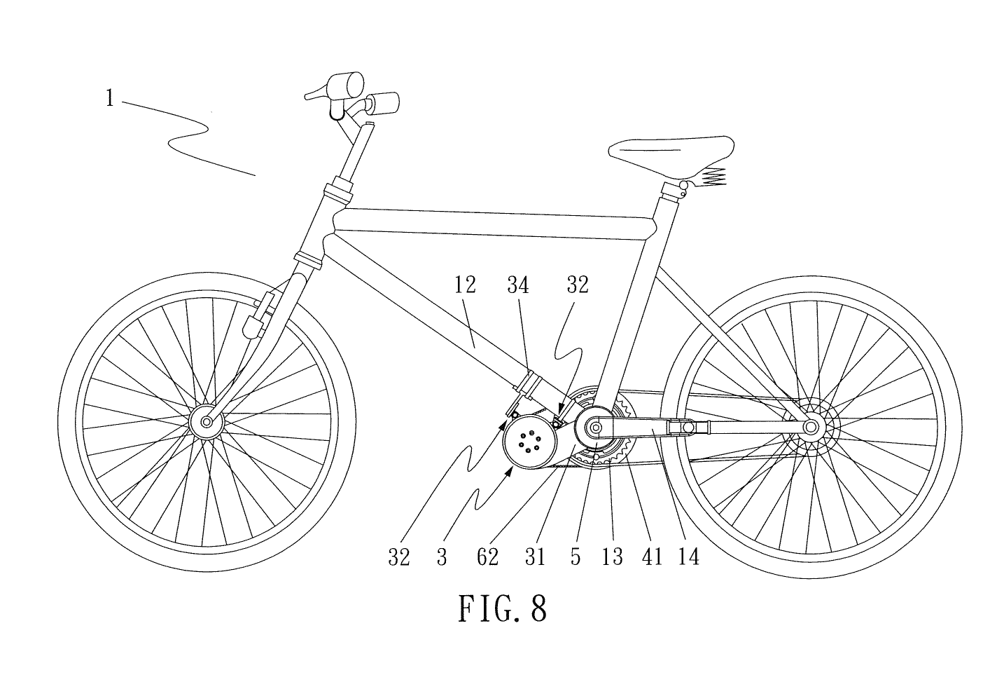

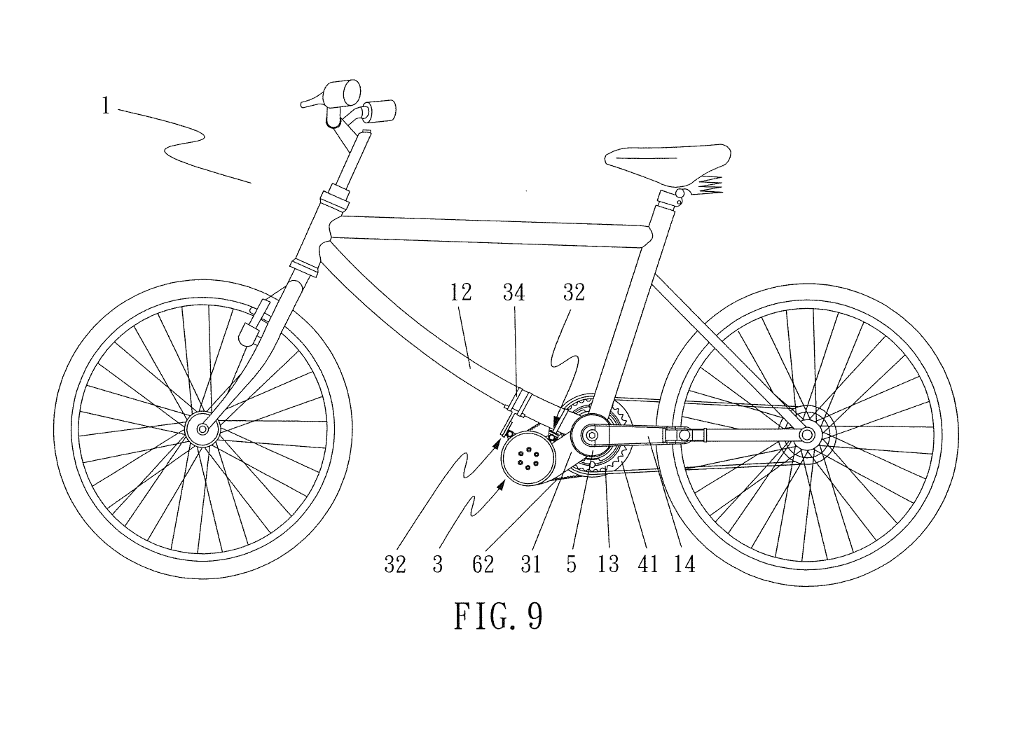

As shown in FIGS. 7 to 9, the present invention can be installed to any type of bicycle frame 12. As shown in FIGS. 4 and 6, the hollow tube 2 extends through the multiple-opening tube which is the bottom bracket 11 of the bicycle frame 12. If the hollow tube 2 cannot fit the bottom bracket 11, the diameter of the hollow tube 2 can be varied by mounting the coated portion 22 to the outside of the hollow tube 2. The coated portion 22 can be sponge, so as to fit with the bottom brackets 11 of different diameters. The extensions 31 of the motor unit 3 are mounted to the protrusions 211 of the caps 21. The caps 21 are then mounted to the hollow tube 2 so that the extensions 31 are clamped between the bottom bracket 11 and the caps 21. The directions of the fixing assemblies 32 are then adjusted. The groove 3221 of the contact portion 322 accommodates the cables of the bicycle 2 and the clamp 34 extends through the hole 3222 and secured to the underside of the bicycle frame 12. The support portion 323 is pivotably connected to the contact portion 322 of another fixing assembly 32 and the cables are engaged with the groove 3231 and secured to the support portion 323 and the bicycle frame 12 by the clamp 34. The motor unit 3 is then firmly secured to the bicycle frame 12. The shaft 4 extends through the hollow tube 2. The first end of the shaft 4 extends through the cap 21 and has a first one-way transmission device 5 connected thereto. The second end of the shaft 4 extends through the other cap 21 and has a chainwheel 13 and the first passive wheel 41 connected thereto. The two cranks 14 are respectively connected to the first and second end of the shaft 4. The motor 6 is located in the motor unit 3 and the motor 6 is secured by the collar 33. The first and second passive wheels 41, 61 are connected by the belt 62. The magnetic induction member 7 is connected to the extension 31 and located close to one end of the first one-way transmission device 5.

When the bicycle transmission device is operated under the electric operation mode, the motor 6 drives the second one-way transmission device 63 and the second passive wheel 61 drives the first passive wheel 41 by the belt 62. The first passive wheel 41 and the shaft 4 are co-rotated to drive the chainwheel 13 which is connected with the wheel of the bicycle 1 so that the bicycle 1 is driven by the motor 6. The shaft 4 and the first one-way transmission device 5 are operated in one direction, and the operational direction of the second one-way transmission device 63 is opposite to that of the first one-way transmission device 5, so that the shaft 4 is freely rotated without output any torque relative to the first one-way transmission device 5. On the contrary, when the power of the motor 6 is low, the rider rotates the cranks 14 manually. Because the cranks 14 are connected with the first one-way transmission device 5, the first one-way transmission device 5 drives the shaft 4 and the chainwheel 13 moves the bicycle 1 forward. In the meanwhile, the first passive wheel 41 is driven by the shaft 4 and the second passive wheel 61 via the belt 62. The second passive wheel 61 is pivotably connected to the second one-way transmission device 63. Because the operation directions of the first and second one-way transmission device 5, 63 are opposite to each other, the second one-way transmission device 63 is freely rotated relative to the motor 6 without output. Therefore, when the user rotates the cranks 14, the magnetic force of the motor 6 does not affect the user who does not waste extra force to overcome the magnetic force.

When the bicycle transmission device is operated under the auxiliary electric operation mode, the user rotates the cranks 14 to drive the first one-way transmission device 5 and the first one-way transmission device 5 drives the shaft 4 to move the bicycle 1 forward. The first passive wheel 41 is driven by the shaft 4 and the second passive wheel 61 is driven via the belt 62. The second passive wheel 61 is pivotably connected to the second one-way transmission device 63. Because the operational direction of the second one-way transmission device 63 is opposite to that of the first one-way transmission device 5, so that the second one-way transmission device 63 is freely rotated without output any torque relative to the motor 6. The motor 6 is still in operation under the auxiliary electric operation mode, the speed of the motor 6 is controlled by the speed-restriction device 64. The motor 6 drives the second one-way transmission device 63, the second passive wheel 61 and the first passive wheel 41 via the belt 62. The shaft 4 is co-rotated to drive the chainwheel 13 to move the bicycle 1 forward. Under the auxiliary electric operation mode, the magnetic induction member 7 is activated and the magnets 71 in the recesses 511 of the ring 51 are rotated due to the pedaling of the user. The magnetic induction member 7 detects the change of magnetic field. Because the ring 51 is rotated by the motor 6 and the user rotating the cranks 14, and the speed of the motor 6 is controlled by the speed-restriction device 64. The speed of the rotation of the cranks 14 can be judged by the difference between the speed of the motor 6 and the speed of the ring 51 so as to drive the bicycle by the electric power. If the direction that the pedals rotate is in opposite to the direction of the movement of the bicycle 1, the ring 51 is not affected by the rotation of the cranks 14. This means that the magnets 71 are not affected by the rotation of the cranks 14 and the magnetic induction member 7 does not judge incorrectly. The speed-restriction device 64 judges and restricts the force that the motor 6 outputs by the change of the magnetic field from the magnetic induction member 7. Therefore, the driving force from the motor 6 is not overly supplied to cause accident.

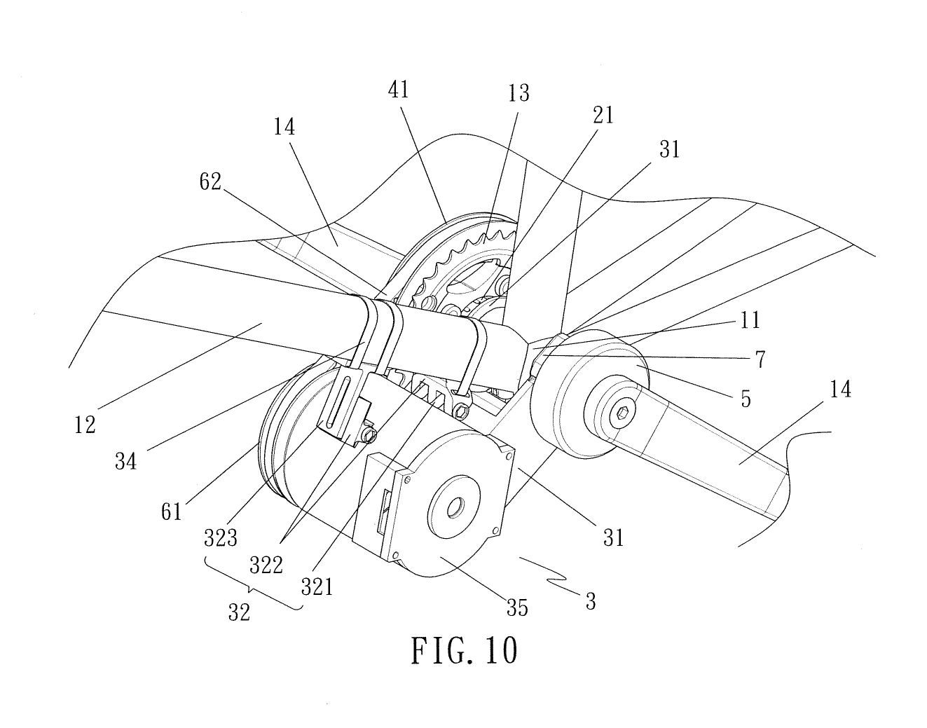

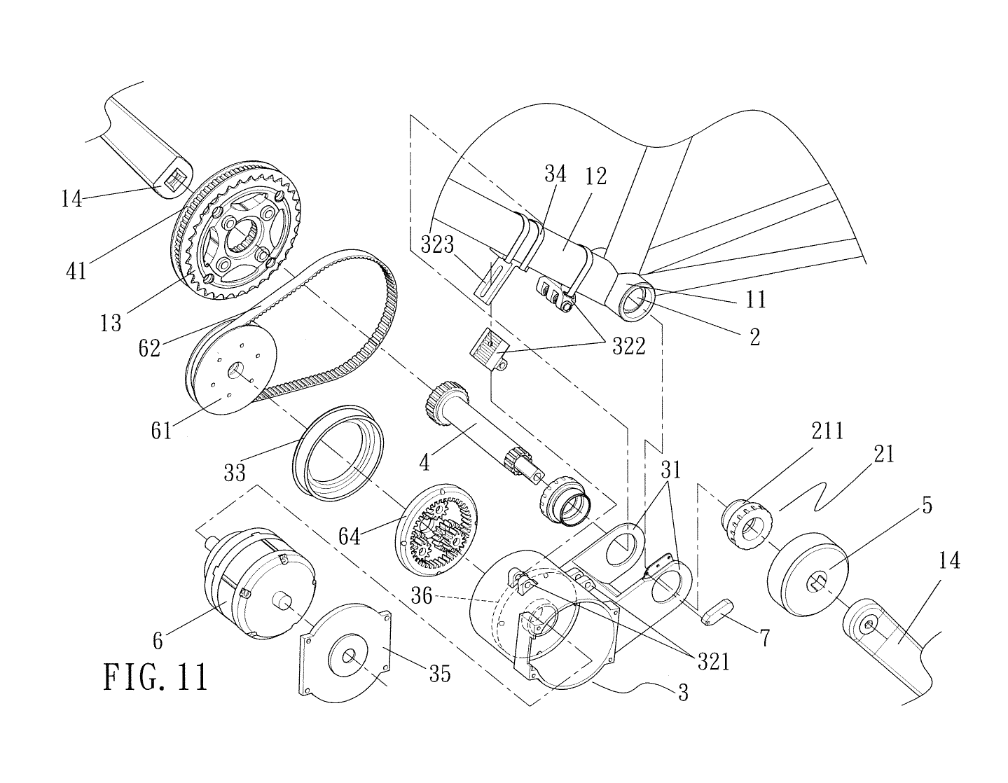

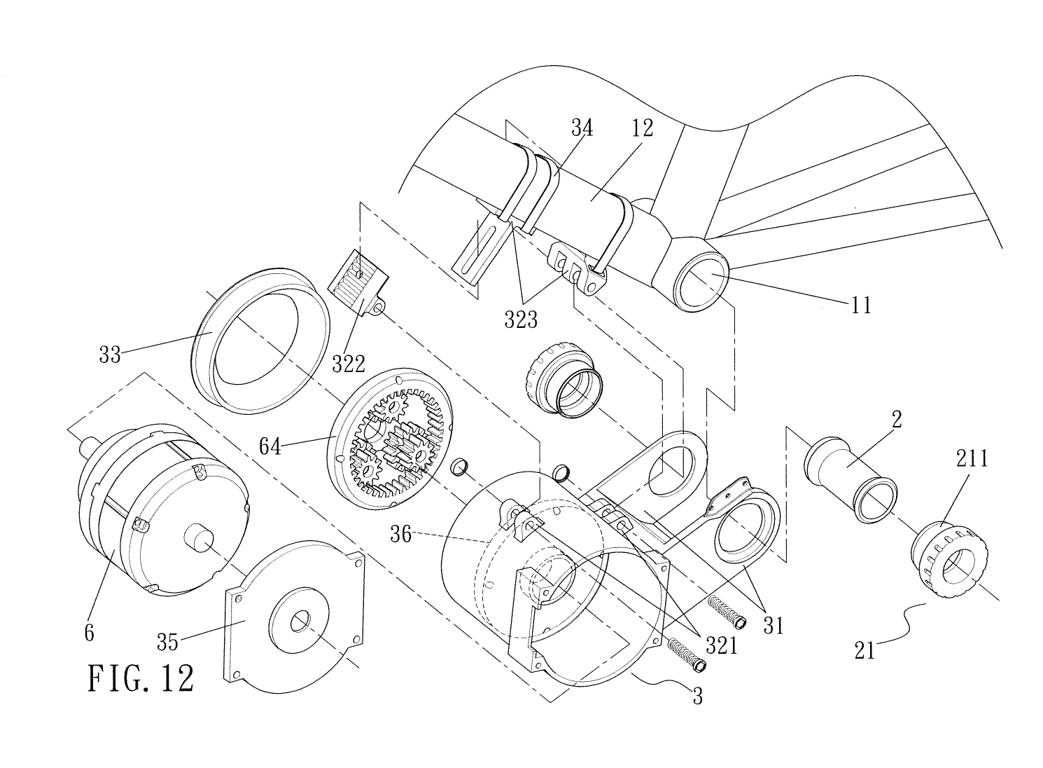

FIGS. 10 to 12 show the second embodiment, the differences of the first and second embodiments are that the motor 6 and the speed-restriction device 64 are separated from each other. The motor unit 3 has an opening which is located opposite to the collar 33. A cover 35 is connected to the opening. A separation member 36 is located between the collar 33 and the cover 35 so as to define a room between the separation member 36 and the collar 33. A space is defined between separation member 36 and the cover 35. The cover 35 covers the motor unit 3 to fix the motor 6 and the speed-restriction device 64 is located in the room. The speed-restriction device 64 is secured by mounting the collar 33 to the motor unit 3. The motor 6 is connected with the speed-restriction device 64 and the speed-restriction device 64 is operatively connected with the second passive wheel 61 so that the two parts are co-rotated. By this specific arrangement, the user can install different motor 6 to be connected with the speed-restriction device 64. When the user rotates the cranks 14 and drives the ring 51 of the first one-way transmission device 5, the speed-restriction device 64 judges and restricts the force that the motor 6 outputs by the change of the magnetic field from the magnetic induction member 7. Because the speed-restriction device 64 and the motor 6 are separated from each other, and the output force from the motor 6 is restricted by the changes of the magnetic field, so that different motors 6 can be used. When switching to the electric operation mode, the speed-restriction device 64 does not change the speed of the motor 6. The speed of the motor 6 can be set by the user. The user can install the motor 6 to the bicycle 1 to operate the bicycle 1 as electric operation bicycle or auxiliary electric operation bicycle. The present invention can be made by lower cost.

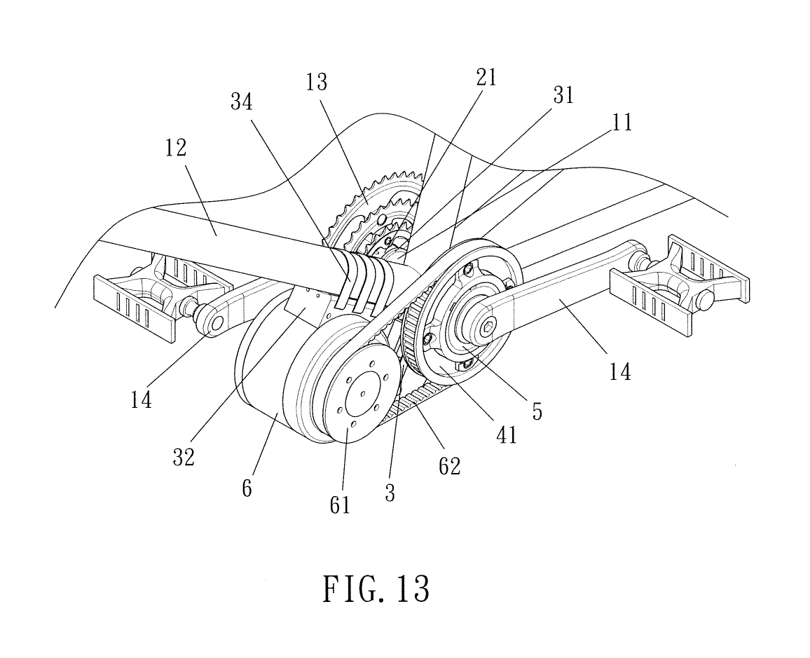

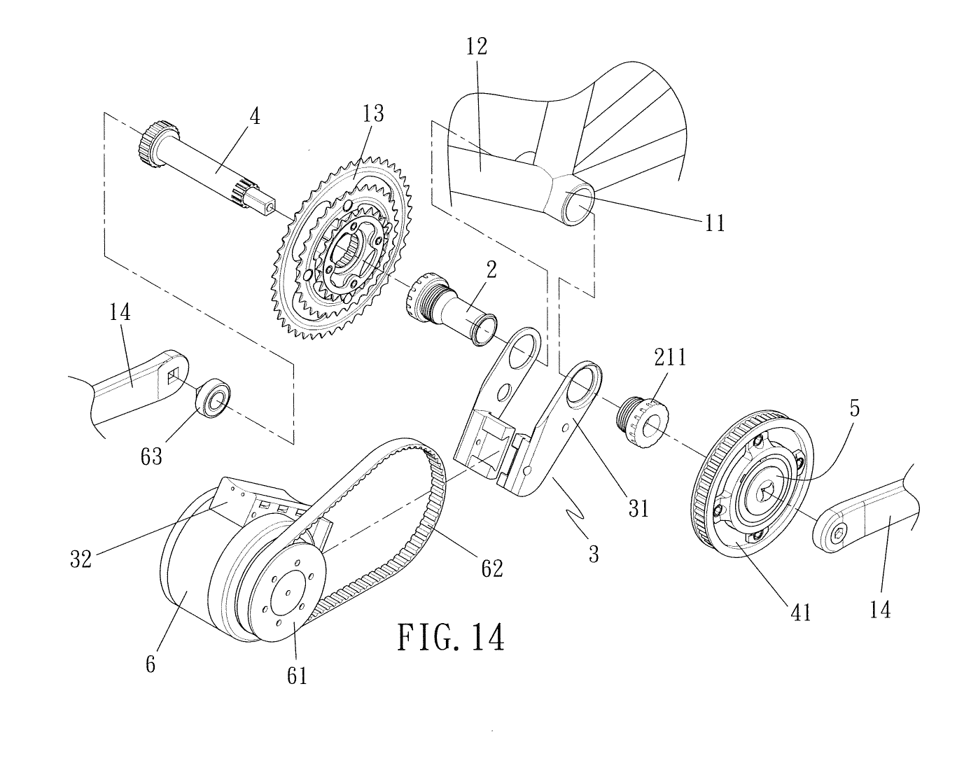

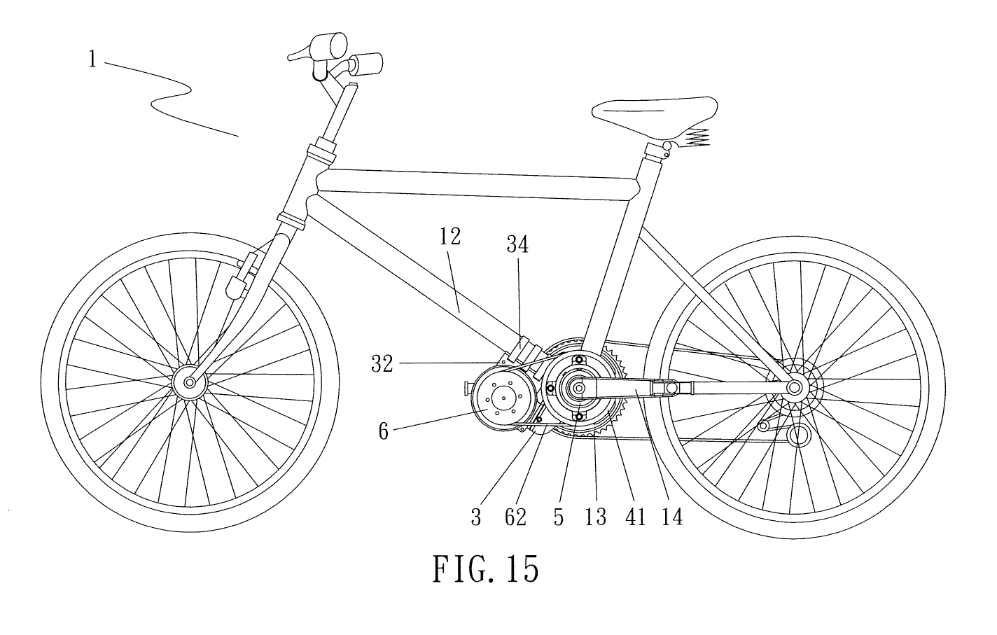

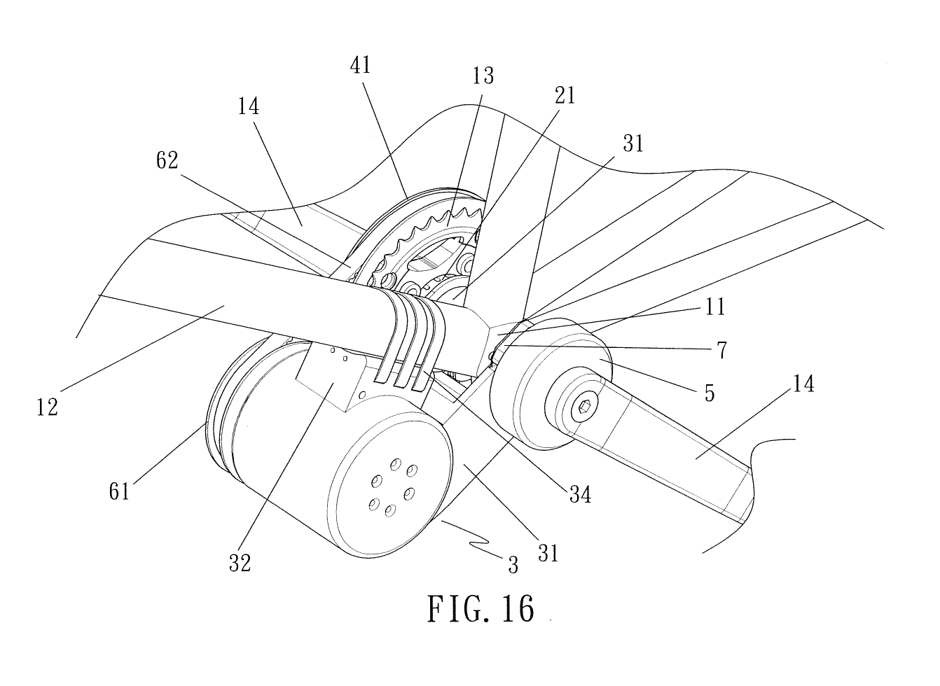

FIGS. 13 to 15 show the third embodiment, the differences of the first and third embodiments are that the shaft 4 extends through the hollow tube 2. The first end of the shaft 4 extends through the cap 21 and has the first one-way transmission device 5 and the first passive wheel 41 connected thereto. The second end of the shaft 4 extends through the other cap 21 and has the chainwheel 13 and the second one-way transmission device 63. The two ends of the shaft 4 are connected to the cranks 14. The motor 6 is located in the motor unit 3 and has a second passive wheel 61 which is connected with the first passive wheel 41 by the belt 62. The second one-way transmission device 63 is operated in opposite direction from that of first one-way transmission device 5. When the motor 6 is secured to the motor unit 3, the angular position of the motor unit 3 is adjusted by the extensions 31. The fixing assemblies 32 are connected to the bicycle frame 12 by the clamps 34. The motor 6 is set not to have the one-way transmission device. The second one-way transmission device 63 is individually installed so that more types of the motors 6 are available. The users can combine different types of the motor unit 3 and the motor 6 so as to operate the bicycle 1 as electric operation bicycle or auxiliary electric operation bicycle.

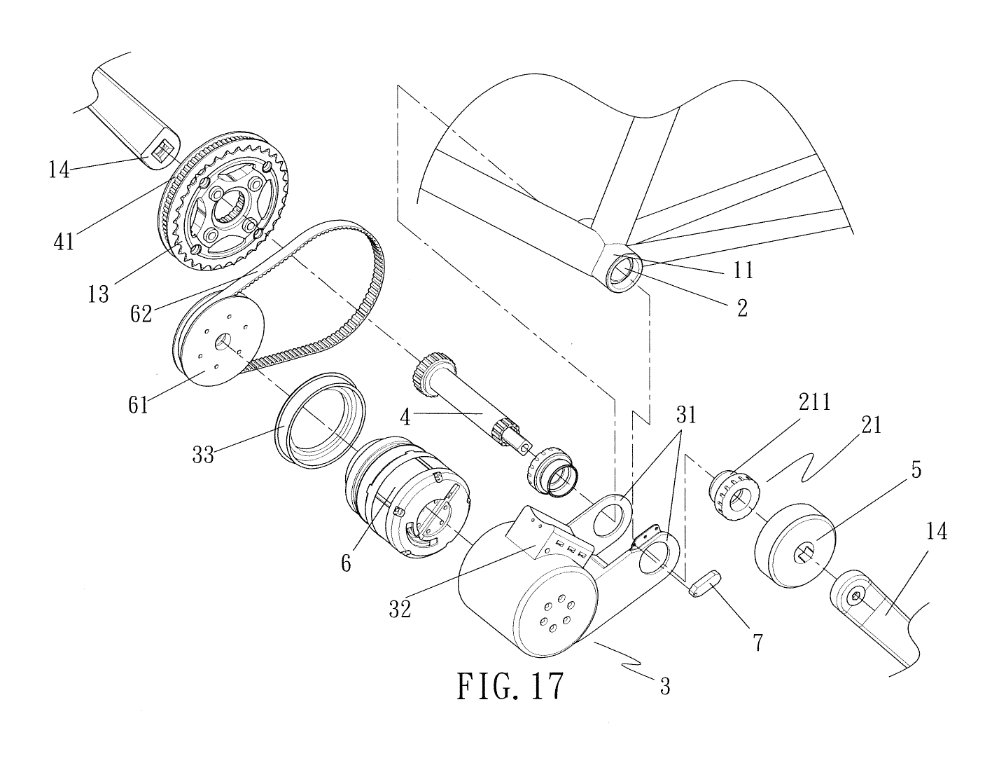

FIGS. 16 and 17 show the fourth embodiment, the differences of the first and fourth embodiments are that the fixing assemblies 32 are the same as that in the third embodiment, and the motor 6 is protected by being located in the motor unit 3. The fixing assemblies 32 ensure that the motor unit 3 does not loose and can be cooperated with more types of parts when needed.

The motor unit 3 of the present invention allows the users to install the normal bicycles into electric bicycles as shown in FIGS. 7 to 9 and 15. The location that the motor 6 is installed is lower than that of the conventional electric bicycle so that the weight center of the bicycle 1 is lowered and the balance on the left and right side of the bicycle 1 is maintained. The motor 6 is located at the lower position of the bicycle 1 does not affect the operation of the user. The operational directions of the first and second one-way transmission devices 5, 63 are opposite to each other so that the user does not need to apply more force to operate the cranks 14 when the electric power is low. The user can switch the operational modes between the electric operation mode and the auxiliary electric operation mode, by cooperation of the magnetic induction member 7, the first one-way transmission device 5 and the speed-restriction device 64, the force that the motor 6 outputs is correctly controlled when switching the bicycle to the auxiliary electric operation mode.

While we have shown and described the embodiment in accordance with the present invention, it should be clear to those skilled in the art that further embodiments may be made without departing from the scope of the present invention.

What is claimed is:

1. A bicycle transmission device comprising:
a hollow tube extending through a multiple-opening tube of a bicycle frame and two caps respectively connected to two ends of the hollow tube, each cap having a protrusion;
a motor unit having two extensions and multiple fixing assemblies, the extensions located corresponding to the two protrusions and secured on the two ends of the multiple-opening tube by the two caps, the fixing assemblies fixing the motor unit to the bicycle frame;
a shaft extending through the hollow tube, a first end of the shaft extending through the cap and having a first one-way transmission device connected thereto, a second end of the shaft extending through the other cap and having a chainwheel and a first passive wheel connected thereto, two cranks respectively connected to the first and second end of the shaft, and
a motor located in the motor unit and having a second passive wheel which is connected with the first passive wheel by a belt.

2. The device as claimed in claim 1, wherein the multiple-opening tube is the bottom bracket.

3. The device as claimed in claim 1, wherein the fixing assemblies each have a lug on the motor unit and pivotably connected to a contact portion, the contact portion is rotatable relative to the lug.

4. The device as claimed in claim 1, wherein the fixing assemblies each have a lug on the motor unit and pivotably connected to a contact portion, the contact portion is rotatable relative to the lug and has a support portion which is movable on the contact portion.

5. The device as claimed in claim 1, wherein the hollow tube has a coated portion mounted to an outside thereof to obtain different diameters and to fit with the multiple-opening tube.

6. The device as claimed in claim 1, wherein the first one-way transmission device is driven by the cranks and the first one-way transmission device indirectly drives the shaft, the cranks drive the chainwheel by rotating in one direction.

7. The device as claimed in claim 1, wherein the motor has a second one-way transmission device which is operated in opposite direction from that of first one-way transmission device, so that the cranks drive the chainwheel in both directions.

8. The device as claimed in claim 7, wherein the first one-way transmission device is driven by the cranks and the first one-way transmission device indirectly drives the shaft, the cranks drive the chainwheel by rotating in one direction.

9. The device as claimed in claim 8, wherein a magnetic induction member is connected to the extension and located close to an end of the first one-way transmission device, a ring is located between the extension and the first one-way transmission device, the ring has multiple recesses and each of the recesses receives a magnet, the magnetic induction member induces changes of magnetic field when the first one-way transmission device is rotated relative to the magnets.

10. The device as claimed in claim 9, wherein a speed-restriction device is connected with the motor and restricts speed of the motor by the induction of the changes of magnetic field.
